(19) United States
(12) Patent Application Publication
(10) Pub. No.: US 2014/0283002 A1
(43) Pub. Date: Sep. 18, 2014

(54) METHOD AND SYSTEM FOR ANONYMOUS CIRCUMVENTION OF INTERNET FILTER FIREWALLS WITHOUT DETECTION OR IDENTIFICATION

(71) Applicant: Stephen Frechette, Newton, MA (US)

(72) Inventor: Stephen Frechette, Newton, MA (US)

(21) Appl. No.: 13/844,247

(22) Filed: Mar. 15, 2013

(51) Int. Cl. H04L 29/06

(52) U.S. Cl. CPC H04L 63/0281
USPC 726/12

(57) ABSTRACT

An improvement invention for a method and system for web users to circumvent web censorship and do so anonymously is presented. The web user is routed through a proxy network that automatically removes code and commands that could be employed to identify the web user, or the Internet address (IP) of the web user. The content of the traffic is also examined for potential advertisement revenue. The improvement is a step that automatically removes code or text that could, upon execution, be employed to identify the web user.

### BACKGROUND OF THE INVENTION

1. Field of the Invention

The improvement invention is for a method and system that enables an Internet user to access blocked Internet content, without detection of the operator of the Internet filter/firewall. The problem that the invention solves is as follows:

The problem is how can Internet users in a country that filters or blocks certain Internet addresses view and post to websites at these blocked Internet addresses, and do so without detection by the operators of the web content filters?

The problem that is solved is twofold, firstly how can the users circumvent the firewall/filter, secondly how can the users do so in a manner that will not identify them as Internet users that have circumvented the firewall and let them post and view to websites anonymously?

An inventive step of this invention is that an Internet user circumvents the filters by accessing a website that is within a window of a popular website that many citizens of the country that is filtering the Internet access must use to conduct commerce, e.g., Dell computer's company website. The proxy website the user is accessing that enables the user to access block websites ensures that the .html code passed to the user within the window does not contain code that could somehow be employed to identify the location of the web surfer, e.g., read a stored Internet history or read a cookie.

An additional inventive step is that all information passed to the user is parsed or scanned by an automated text editor to ensure no commands or information is given to the user that would cause the user that is trying to stay anonymous to give away their location.

The invention additionally consists of a method and system in which the proxy website, which the user operates a windows within to surf blocked websites, encrypts all communication via the HTTPS protocol. The proxy website passes encrypted traffic to all users in a manner that forms and shapes all traffic so that users of the proxy and their traffic is indistinguishable from regular users of the website that do not operate any commands in the web proxy windows.

2. Description of Prior Art

In prior art methods and systems enable Internet users to circumvent Internet filters, but they exhibit at least one of the following three shortcomings, either they lack the ability for the Internet user to use them anonymously, or they lack the ability for user to avoid detection that they are using the web proxy, or they require software installation on the client device.

This improvement invention differs from the previously mentioned prior art in that the invention enables all the following user cases, and exhibits none of the previous shortcomings.

This invention also differs from previous art in that its users that circumvent Internet filters can do so both anonymously and in a manner that cannot be blocked or disables, without blocking or disabling many of the websites that would provide the web surfing windows.

The invention differs from previous art in that previous art requires installation of software on the client device, thus making detection by the authorities trying to discover users. Also, unlike, other methods the anonymity of the user is protected by scanning all traffic through the proxy and removing or altering any .html code or embedded scripts or applications that would give away the identity of the user. The code that executes on the proxy server that filters .html code to prevent any code from executing could be used to identify the user, could also scan the .html that the user is observing for key words for use with advertisers.

### BRIEF SUMMARY OF THE INVENTION

The improvement invention improves a method and system for individuals to circumvent web censorship and add and view content anonymously from any Internet connection.

Additionally, the improvement invention differs from previous art in that it automatically removes 105 code or strings within any data sent to a web browser that could be employed to identify the web browser, e.g., determine their Internet Address (IP) via commanding a connection to be made to another machine without connecting through the Proxy 110. Also, the code or strings removed from the .html code could be commands to read cookies or Adobe Flash cookies, which are more difficult to clear than standard cookies. The improvement step is performed by a web server or web proxy machine.

Another embodiment of the improvement invention for existing web proxy servers that increase user anonymity, is that the automatic text and command editor scans text or code for words or commands previously tagged by advertisers as of interest.

In other aspects, the invention provides a system having features and advantages corresponding to those discussed above.

### BRIEF DESCRIPTION OF THE DRAWINGS

FIG. 1 is a flow diagram that illustrates the physical steps for the improvement invention, in which an automatic text and command editor prevents the identity of an Internet user from being discovered.

FIG. 2 illustrates an exemplary method and system for the prevention of identification of an internet user via automatic text and command editor within a web server or web proxy that is consistent with the presented improvement invention and noted in FIG. 1 item 105.

FIG. 3 illustrates an exemplary method and system for the prevention of identification of an internet user via automatic text and command editor within a web server or web proxy that is consistent with the presented improvement invention and noted in FIG. 1 item 105.

FIG. 4 is a diagram of an exemplary apparatus that may perform various operations in a manner consistent with the presented improve invention.

### DETAILED DESCRIPTION OF THE INVENTION

The presented improvement invention is for a method and system that aids in keeping individuals identity's a secret while they are surfing the Internet.

The uses of the invention includes but are not limited to the following scenarios:

In this scenario an Internet user desires to keep his identity a secret while creating content or viewing content somewhere on the Internet, this scenario is presented in FIG. 1 and FIG. 2.

In this embodiment of the invention an Internet user connects to a web server or web proxy in order to circumvent web censorship technologies. The Internet user both attempts to avoid filters that censor web content, and attempts to determine their identity. The automatic text and command editor 105 for this embodiment is provided in FIG. 2.

In another embodiment of the invention an Internet user who desires to remain anonymous, but will accept advertisements based on the content of the websites they visit.

The Internet attempts to remain anonymous, but advertisement based on the content they view are acceptable. This automatic text and command editor 105 for this embodiment is provided in FIG. 3.

FIG. 1 illustrates the control and dataflow necessary to improve upon a method and system's physical steps that tries to prevent an Internet user's identity from being discovered. First, the Internet user attempts to create, publish, refresh, or consume data displayed on a client device or webpage 100′. Standard control signals that route the user's data and traffic to the desired destination is provided by the web server or web proxy 110′. The data that is passed to the client 100′ must pass through an automatic text and command editor 105, which removes information that would cause the location of the Internet user to be discovered. All information passed from the censored web server 120′, and the Internet user 100′ must pass through both the standard proxy 107, which facilitates the connection, and the automatic text and command editor 105.

The communication from the user 100′ to the web server/web proxy 110′ is encrypted. The communication from the web server/web proxy 100′ to the webpage 120′ may be either encrypted or unencrypted.

FIG. 2 illustrates the data flow necessary for an implementation of the automatic text and command editor 110′. Firstly, the Internet user who desires to perform an action 100′ must be routed through a proxy server that contains a mechanism to perform the extraction or substitution of strings of .html code that could identify the user or client device 110′, which is employed in 100. The censored content in 120′ is thus routed through 110′. The list of commands and strings of text characters to remove from the .html code is contained in 200, and is removed or substituted with null strings by the action taken by 103. The .html code may contain embedded Adobe flash scripts, JavaScript, Cascading style sheets, CSS, or other embedded commands that must be examined because they may contain request for cookie reads, or know URLs that are specifically inserted by third parties into websites to track and identify Users.

FIG. 3 illustrates the data flow necessary for an implementation of the copy of text that identifies products or locations or services 110′. Firstly, the Internet user who desires to perform an action 100′ must be routed through a proxy server that contains a mechanism to perform the copy of text that identifies products or locations or services 110′, which is employed in 100′. The censored content in 120's is thus routed through 110′. The list of commands and strings of text characters that identifies products or locations or services, within the .html code, is contained in 300. A record or log of the text strings of products or locations or services found both in 300 and in the .html that pass through 110′ and are copied by actions in 303, and are kept and maintained in 310. The information stored in data store 310 is sold to advertisers for advertisement revenue for advertisements displayed to the web user 100′, which are selected based upon the information in 310. The text file or store of text 300 of products or locations or services may contain both standard string of text characters and regular expressions, which are employed for parsing of text and contains wildcards that enable matching of described string formats. The copying of string action 303, also includes parsing text via regular expressions, and then copying the matches.

FIG. 4 is a high level diagram of a machine that may perform one or more of the operations discussed above, including 100′ 110′ 120′. The improvement invention requires the use of a machine to store data, accept inputs from the user, output data to a human readable display, and connect to servers over the Internet. The servers have the same requirements as the previously described machines except the inputs, outputs, and displays are provided through a network connection and the input/output is performed on another machine connected to the network. The machine may be a personal computer, cell phone, or any machine capable of accessing a server and which includes one or more processors 410, storage devices 420, one or more input/output interface unites 430, and one or more system buses and/or networks 440 for facilitating the communication of information among the coupled elements. The machine must also contain one or more input devices 432 and one or more output devices 434 that may be coupled with the one or more input/output interfaces 430. The output devices 434 may include a monitor or cell phone display screen or other type of display device, which may also be connected to the system bus 440 via an appropriate interface. The processors 410, may execute any number of possible operating systems, including but not limited to Linux, Solaris, Windows-based, Android, iOS, webOS, and any other operating system capable of supporting a web-browser either on a cell phone, personal computer, server, or web-enabled television.

What is claimed is:

1. A computer-implemented method for the prevention of web user identification through the use of a proxy server, in which the user is in control of a computer/machine that accesses the Internet and displaying images to the user via a computer screen, wherein the improvement comprises the following steps:
a) extraction from .html code and all information sent to a client browser, by a computer system, including but not limited to internet address information, or commands to read Internet history or browser cookies, or Adobe flash cookies, or any command or URL that could be used to identify a web user;

2. The method of claim 1, wherein the improvement comprises the step of extraction of any potential means to determine identity from .html code, in which the .html code contains embedded machine code or command scripts, including but not limited to CCS or JavaScript, that could execute a command that would result in the location of the user being determined.

3. The method of claim 1, wherein the improvement comprises the step of extraction of any potential means to determine identity from an communications to a web browser, in which the action of extraction or substitution of commands or strings of text characters is performed within a proxy server that has the purpose of hiding the true IP address of the machine in which the web browser is running/executing.

4. The method of claim 1, wherein the improvement comprises the step of extraction of requests to download information via a URL from communications to a web browser, in which the download from the URL would not be forwarded or routed through the proxy machine, or in which the true IP address of the machine in which the web browser is running/executing could be determined.

5. The method of claim 1, wherein the improvement is that the proxy server is hosted within a window on a popular website that is of national interest, and thus access would not be block.

6. The method of claim 1, wherein the improvement comprises the step of the extraction, in which the extraction employs regular expressions used for text parsing.

7. A computer-implemented method for scanning communications to a web browser that are routed through a proxy network, in which the user is in control of a computer/machine that accesses the Internet and displays images to the user via a computer screen, wherein the improvement comprises the following steps:
a) reading, from a text file or store of records or database, text or strings of characters that identify products or locations or services.
b) copying, from .html code and all information sent to a client browser, select text or strings of characters that identify products or locations or services that have been read in the previous step.
c) recording/logging, to a text file or store of records or database, select text or strings of characters that identify products or locations or services that have been copied in the previous step and read in the first step.

8. The method of claim 7, wherein the improvement comprises the step of reading, which includes reading of regular expressions used for text parsing.

9. The method of claim 7, wherein the improvement comprises the step of copying, which includes the copying of matches to the regular expressions used for text parsing.

10. The method of claim 7, wherein the improvement comprises the step of copying from .html code, in which the .html code contains embedded machine code or command scripts, including but not limited to CCS or JavaScript.
